(19) United States
(12) Patent Application Publication
(10) Pub. No.: US 2025/0240688 A1
(43) Pub. Date: Jul. 24, 2025

(54) APPARATUSES, METHODS, AND COMPUTER READABLE MEDIA FOR UPDATING SYSTEM INFORMATION

(71) Applicant: Nokia Technologies Oy, Espoo (FI)

(72) Inventors: Henri Markus KOSKINEN, Espoo (FI); Ilkka Antero KESKITALO, Oulu (FI)

(21) Appl. No.: 18/701,973

(22) PCT Filed: Oct. 20, 2021
(86) PCT No.: PCT/EP2021/079089

§ 371 Date: Apr. 17, 2024

(51) Int. Cl. H04W 36/12; H04W 36/00; H04W 36/24

(52) U.S. Cl. CPC H04W 36/12; H04W 36/0064; H04W 36/249

(57) ABSTRACT

An apparatus may include at least one processor and at least one memory. The at least one memory may include computer program code, and the at least one memory and the computer program code may be configured to, with the at least one processor, cause the apparatus as a terminal device in an integrated access and backhaul network to perform receiving, a system information change indication from a network device associated with an integrated access and backhaul node in the integrated access and backhaul network or system information via a dedicated signaling from another network device associated with a donor in the integrated access and backhaul network, before an expiry of a period after which the terminal device autonomously acquires the system information from the another network device, and restarting the period in a case of receiving the system information change indication or the system information via the dedicated signaling.

### TECHNICAL FIELD

Various embodiments relate to apparatuses, methods, and computer readable media for updating system information (SI).

### BACKGROUND

In an integrated access and backhaul (IAB) network, more than one cells, e.g., two cells, may reside on the same physical IAB node but on different logical distributed units (DUs), which may use the same physical cell resources. In a case of inter-donor migration of the IAB node, a user equipment (UE) device connected to the IAB node will hand over from a cell of one logical DU controlled by a central unit (CU) of a donor to a cell of another logical DU controlled by another CU of another donor, and the migrating IAB node will change its SI from indicating new radio cell global identifier (NCGI) associated with the CU to indicating another NCGI associated with the another CU, which is done without notifying the UE device of the SI change. The NCGI may be broadcast via, e.g., system information block 1 (SIB1), and in case after the SIB1 change but before handover (HO), the UE device may autonomously acquire an up-to-date SIB1. For example, the UE device may delete any stored version of a SIB after 3 hours from the moment it was successfully confirmed as valid, and the UE device may apply the SI acquisition procedure whenever the UE device does not have a valid version of a stored SIB. If the UE device observes a change in NCGI that was not pre-advertised by the network in the form of SI change indication, the UE device may treat it as an error case.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is an apparatus. The apparatus may include at least one processor and at least one memory. The at least one memory may include computer program code, and the at least one memory and the computer program code may be configured to, with the at least one processor, cause the apparatus as a terminal device in an integrated access and backhaul network to perform receiving, a system information change indication from a network device associated with an integrated access and backhaul node in the integrated access and backhaul network or system information via a dedicated signaling from another network device associated with a donor in the integrated access and backhaul network, before an expiry of a period after which the terminal device autonomously acquires the system information from the another network device; and restarting the period in a case of receiving the system information change indication or the system information via the dedicated signaling.

In a second aspect, disclosed is an apparatus. The apparatus may include at least one processor and at least one memory. The at least one memory may include computer program code, and the at least one memory and the computer program code may be configured to, with the at least one processor, cause the apparatus as a network device associated with an integrated access and backhaul node in an integrated access and backhaul network to perform broadcasting, to at least one first terminal device associated with a cell of a distributed unit of the integrated access and backhaul node, a system information change indication on the cell before an expiry of a first period after which the at least one first terminal device autonomously acquires system information on the cell.

In some example embodiments, the at least one memory and the computer program code may be further configured to, with the at least one processor, cause the apparatus to further perform transmitting, to a donor in the integrated access and backhaul network, an identifier of at least one second terminal device associated with the cell and unable to receive broadcast system information.

In some example embodiments, the at least one memory and the computer program code may be further configured to, with the at least one processor, cause the apparatus to further perform receiving, from a donor in the integrated access and backhaul network, a configuration for broadcasting the system information change indication, wherein the system information change indication may be broadcast according to the configuration.

In some example embodiments, the configuration may comprise a second period for broadcasting the system information change indication, and the second period may be shorter than the first period.

In some example embodiments, the configuration may be received via an information element, and the configuration may comprise information indicative of starting or stopping the broadcasting of the system information change indication.

In some example embodiments, the system information change indication may be broadcast when initiating a mobile termination of the network device to hand over from the donor to another donor in the integrated access and backhaul network.

In some example embodiments, the at least one memory and the computer program code may be further configured to, with the at least one processor, cause the apparatus to further perform reinitiating the broadcasting of the system information change indication before the expiry of the first period, in a case where a timing for a migration from the distributed unit associated with the donor to a distributed unit associated with the another donor in the integrated access and backhaul network is after the expiry of the first period.

In some example embodiments, the system information change indication may be broadcast when a migration from the distributed unit associated with the donor to a distributed unit associated with the another donor in the integrated access and backhaul network is ongoing.

In some example embodiments, the system information change indication may be broadcast in a physical downlink control channel short message.

In a third aspect, disclosed is an apparatus. The apparatus may include at least one processor and at least one memory. The at least one memory may include computer program code, and the at least one memory and the computer program code may be configured to, with the at least one processor, cause the apparatus as a network device associated with a donor in an integrated access and backhaul network to perform configuring an integrated access and backhaul node in the integrated access and backhaul network for broadcasting a system information change indication to at least one first terminal device associated with a cell of a distributed unit of the integrated access and backhaul node before an expiry of a first period after which the at least one first terminal device autonomously acquires system information on the cell; and transmitting the configuration to the integrated access and backhaul node.

In some example embodiments, the configuration may comprise a second period for broadcasting the system information change indication, and the second period may be shorter than the first period.

In some example embodiments, the configuration may be transmitted via an information element, and the configuration may comprise to information indicative of starting or stopping the broadcasting of the system information change indication.

In some example embodiments, the at least one memory and the computer program code may be further configured to, with the at least one processor, cause the apparatus to further perform receiving, from the integrated access and backhaul node, an identifier of at least one second terminal device associated with the cell and unable to receive broadcast system information, and transmitting, to the at least one second terminal device, the system information via a dedicated signaling.

In some example embodiments, the system information may be transmitted with a third period, and the third period may be shorter than the first period after which the at least one second terminal device autonomously acquires the system information.

In some example embodiments, the system information may be transmitted when a mobile termination of the integrated access and backhaul node is to hand over to from the donor to another donor in the integrated access and backhaul network.

In some example embodiments, the at least one memory and the computer program code may be further configured to, with the at least one processor, cause the apparatus to further perform reinitiating the transmission of the system information before the expiry of the first period after which the at least one second terminal device autonomously acquires the system information, in a case where a timing for a migration from the distributed unit associated with the donor to a distributed unit associated with the another donor in the integrated access and backhaul network is after the expiry of the first period.

In some example embodiments, the system information may be transmitted when a migration from the distributed unit associated with the donor to a distributed unit associated with the another donor in the integrated access and backhaul network is ongoing.

In a fourth aspect, disclosed is a method performed by a terminal device in an integrated access and backhaul network. The method may include receiving, a system information change indication from a network device associated with an integrated access and backhaul node in the integrated access and backhaul network or system information via a dedicated signaling from another network device associated with a donor in the integrated access and backhaul network, before an expiry of a period after which the terminal device autonomously acquires the system information from the another network device; and restarting the period in a case of receiving the system information change indication or the system information via the dedicated signaling.

In a fifth aspect, disclosed is a method performed by a network device associated with an integrated access and backhaul node in an integrated access and backhaul network. The method may include broadcasting, to at least one first terminal device associated with a cell of a distributed unit of the integrated access and backhaul node, a system information change indication on the cell before an expiry of a first period after which the at least one first terminal device autonomously acquires system information on the cell.

In some example embodiments, the method may further include transmitting, to a donor in the integrated access and backhaul network, an identifier of at least one second terminal device associated with the cell and unable to receive broadcast system information.

In some example embodiments, the method may further include receiving, from a donor in the integrated access and backhaul network, a configuration for broadcasting the system information change indication, wherein the system information change indication may be broadcast according to the configuration.

In some example embodiments, the configuration may comprise a second period for broadcasting the system information change indication, and the second period may be shorter than the first period.

In some example embodiments, the configuration may be received via an information element, and the configuration may comprise information indicative of starting or stopping the broadcasting of the system information change indication.

In some example embodiments, the system information change indication may be broadcast when initiating a mobile termination of the network device to hand over from the donor to another donor in the integrated access and backhaul network.

In some example embodiments, the method may further include reinitiating the broadcasting of the system information change indication before the expiry of the first period, in a case where a timing for a migration from the distributed unit associated with the donor to a distributed unit associated with the another donor in the integrated access and backhaul network is after the expiry of the first period.

In some example embodiments, the system information change indication may be broadcast when a migration from the distributed unit associated with the donor to a distributed unit associated with the another donor in the integrated access and backhaul network is ongoing.

In some example embodiments, the system information change indication may be broadcast in a physical downlink control channel short message.

In a sixth aspect, disclosed is a method performed by a network device associated with a donor in an integrated access and backhaul network. he method may include configuring an integrated access and backhaul node in the integrated access and backhaul network for broadcasting a system information change indication to at least one first terminal device associated with a cell of a distributed unit of the integrated access and backhaul node before an expiry of a first period after which the at least one first terminal device autonomously acquires system information on the cell; and transmitting the configuration to the integrated access and backhaul node.

In some example embodiments, the configuration may comprise a second period for broadcasting the system information change indication, and the second period may be shorter than the first period.

In some example embodiments, the configuration may be transmitted via an information element, and the configuration may comprise information indicative of starting or stopping the broadcasting of the system information change indication.

In some example embodiments, the method may further include receiving, from the integrated access and backhaul node, an identifier of at least one second terminal device associated with the cell and unable to receive broadcast system information, and transmitting, to the at least one second terminal device, the system information via a dedicated signaling.

In some example embodiments, the system information may be transmitted with a third period, and the third period may be shorter than the first period after which the at least one second terminal device autonomously acquires the system information.

In some example embodiments, the system information may be transmitted when a mobile termination of the integrated access and backhaul node is to hand over from the donor to another donor in the integrated access and backhaul network.

In some example embodiments, the method may further include reinitiating the transmission of the system information before the expiry of the first period after which the at least one second terminal device autonomously acquires the system information, in a case where a timing for a migration from the distributed unit associated with the donor to a distributed unit associated with the another donor in the integrated access and backhaul network is after the expiry of the first period.

In some example embodiments, the system information may be transmitted when a migration from the distributed unit associated with the donor to a distributed unit associated with the another donor in the integrated access and backhaul network is ongoing.

In a seventh aspect, disclosed is an apparatus. The apparatus as a terminal device in an integrated access and backhaul network may include means for receiving, a system information change indication from a network device associated with an integrated access and backhaul node in the integrated access and backhaul network or system information via a dedicated signaling from another network device associated with a donor in the integrated access and backhaul network, before an expiry of a period after which the terminal device autonomously acquires the system information from the another network device; and means for restarting the period in a case of receiving the system information change indication or the system information via the dedicated signaling.

In an eighth aspect, disclosed is an apparatus. The apparatus as a network device associated with an integrated access and backhaul node in an integrated access and backhaul network include means for broadcasting, to at least one first terminal device associated with a cell of a distributed unit of the integrated access and backhaul node, a system information change indication on the cell before an expiry of a first period after which the at least one first terminal device autonomously acquires system information on the cell.

In some example embodiments, the apparatus may further include means for transmitting, to a donor in the integrated access and backhaul network, an identifier of at least one second terminal device associated with the cell and unable to receive broadcast system information.

In some example embodiments, the apparatus may further include means for receiving, from a donor in the integrated access and backhaul network, a configuration for broadcasting the system information change indication, wherein the system information change indication may be broadcast according to the configuration.

In some example embodiments, the configuration may comprise a second period for broadcasting the system information change indication, and the second period may be shorter than the first period.

In some example embodiments, the configuration may be received via an information element, and the configuration may comprise information indicative of starting or stopping the broadcasting of the system information change indication.

In some example embodiments, the system information change indication may be broadcast when initiating a mobile termination of the network device to hand over from the donor to another donor in the integrated access and backhaul network.

In some example embodiments, the apparatus may further include means for reinitiating the broadcasting of the system information change indication before the expiry of the first period, in a case where a timing for a migration from the distributed unit associated with the donor to a distributed unit associated with the another donor in the integrated access and backhaul network is after the expiry of the first period.

In some example embodiments, the system information change indication may be broadcast when a migration from the distributed unit associated with the donor to a distributed unit associated with the another donor in the integrated access and backhaul network is ongoing.

In some example embodiments, the system information change indication may be broadcast in a physical downlink control channel short message.

In a ninth aspect, disclosed is an apparatus. The apparatus as a network device associated with a donor in an integrated access and backhaul network include means for configuring an integrated access and backhaul node in the integrated access and backhaul network for broadcasting a system information change indication to at least one first terminal device associated with a cell of a distributed unit of the integrated access and backhaul node before an expiry of a first period after which the at least one first terminal device autonomously acquires system information on the cell; and means for transmitting the configuration to the integrated access and backhaul node.

In some example embodiments, the configuration may comprise a second period for broadcasting the system information change indication, and the second period may be shorter than the first period.

In some example embodiments, the configuration may be transmitted via an information element, and the configuration may comprise information indicative of starting or stopping the broadcasting of the system information change indication.

In some example embodiments, the apparatus may further include means for receiving, from the integrated access and backhaul node, an identifier of at least one second terminal device associated with the cell and unable to receive broadcast system information, and means for transmitting, to the at least one second terminal device, the system information via a dedicated signaling.

In some example embodiments, the system information may be transmitted with a third period, and the third period may be shorter than the first period after which the at least one second terminal device autonomously acquires the system information.

In some example embodiments, the system information may be transmitted when a mobile termination of the integrated access and backhaul node is to hand over from the donor to another donor in the integrated access and backhaul network.

In some example embodiments, the apparatus may further include means for reinitiating the transmission of the system information before the expiry of the first period after which the at least one second terminal device autonomously acquires the system information, in a case where a timing for a migration from the distributed unit associated with the donor to a distributed unit associated with the another donor in the integrated access and backhaul network is after the expiry of the first period.

In some example embodiments, the system information may be transmitted when a migration from the distributed unit associated with the donor to a distributed unit associated with the another donor in the integrated access and backhaul network is ongoing.

In a tenth aspect, a computer readable medium is disclosed. The computer readable medium may include instructions stored thereon for causing an apparatus as a terminal device in an integrated access and backhaul network to perform receiving, a system information change indication from a network device associated with an integrated access and backhaul node in the integrated access and backhaul network or system information via a dedicated signaling from another network device associated with a donor in the integrated access and backhaul network, before an expiry of a period after which the terminal device autonomously acquires the system information from the another network device; and restarting the period in a case of receiving the system information change indication or the system information via the dedicated signaling.

In an eleventh aspect, a computer readable medium is disclosed. The computer readable medium may include instructions stored thereon for causing an apparatus as a network device associated with an integrated access and backhaul node in an integrated access and backhaul network to perform broadcasting, to at least one first terminal device associated with a cell of a distributed unit of the integrated access and backhaul node, a system information change indication on the cell before an expiry of a first period after which the at least one first terminal device autonomously acquires system information on the cell.

In some example embodiments, the computer readable medium may further include instructions stored thereon for causing the apparatus to further perform transmitting, to a donor in the integrated access and backhaul network, an identifier of at least one second terminal device associated with the cell and unable to receive broadcast system information.

In some example embodiments, the computer readable medium may further include instructions stored thereon for causing the apparatus to further perform receiving, from a donor in the integrated access and backhaul network, a configuration for broadcasting the system information change indication, wherein the system information change indication may be broadcast according to the configuration.

In some example embodiments, the configuration may comprise a second period for broadcasting the system information change indication, and the second period may be shorter than the first period.

In some example embodiments, the configuration may be received via an information element, and the configuration may comprise information indicative of starting or stopping the broadcasting of the system information change indication.

In some example embodiments, the system information change indication may be broadcast when initiating a mobile termination of the network device to hand over from the donor to another donor in the integrated access and backhaul network.

In some example embodiments, the computer readable medium may further include instructions stored thereon for causing the apparatus to further perform reinitiating the broadcasting of the system information change indication before the expiry of the first period, in a case where a timing for a migration from the distributed unit associated with the donor to a distributed unit associated with the another donor in the integrated access and backhaul network is after the expiry of the first period.

In some example embodiments, the system information change indication may be broadcast when a migration from the distributed unit associated with the donor to a distributed unit associated with the another donor in the integrated access and backhaul network is ongoing.

In some example embodiments, the system information change indication may be broadcast in a physical downlink control channel short message.

In a twelfth aspect, a computer readable medium is disclosed. The computer readable medium may include instructions stored thereon for causing an apparatus as a network device associated with a donor in an integrated access and backhaul network to perform configuring an integrated access and backhaul node in the integrated access and backhaul network for broadcasting a system information change indication to at least one first terminal device associated with a cell of a distributed unit of the integrated access and backhaul node before an expiry of a first period after which the at least one first terminal device autonomously acquires system information on the cell; and transmitting the configuration to the integrated access and backhaul node.

In some example embodiments, the configuration may comprise a second period for broadcasting the system information change indication, and the second period may be shorter than the first period.

In some example embodiments, the configuration may be transmitted via an information element, and the configuration may comprise information indicative of starting or stopping the broadcasting of the system information change indication.

In some example embodiments, the computer readable medium may further include instructions stored thereon for causing the apparatus to further perform receiving, from the integrated access and backhaul node, an identifier of at least one second terminal device associated with the cell and unable to receive broadcast system information, and transmitting, to the at least one second terminal device, the system information via a dedicated signaling.

In some example embodiments, the system information may be transmitted with a third period, and the third period may be shorter than the first period after which the at least one second terminal device autonomously acquires the system information.

In some example embodiments, the system information may be transmitted when a mobile termination of the integrated access and backhaul node is to hand over from the donor to another donor in the integrated access and backhaul network.

In some example embodiments, the computer readable medium may further include instructions stored thereon for causing the apparatus to further perform reinitiating the transmission of the system information before the expiry of the first period after which the at least one second terminal device autonomously acquires the system information, in a case where a timing for a migration from the distributed unit associated with the donor to a distributed unit associated with the another donor in the integrated access and backhaul network is after the expiry of the first period.

In some example embodiments, the system information may be transmitted when a migration from the distributed unit associated with the donor to a distributed unit associated with the another donor in the integrated access and backhaul network is ongoing.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence diagram for updating SI according to embodiments of the present disclosure.

FIG. 2 shows a flow chart illustrating an example method for updating SI according to embodiments of the present disclosure.

FIG. 3 shows a flow chart illustrating an example method for updating SI according to embodiments of the present disclosure.

FIG. 4 shows a flow chart illustrating an example method for updating SI according to embodiments of the present disclosure.

FIG. 5 shows a block diagram illustrating an example apparatus for updating SI according to embodiments of the present disclosure.

FIG. 6 shows a block diagram illustrating an example apparatus for updating SI according to embodiments of the present disclosure.

FIG. 7 shows a block diagram illustrating an example apparatus for updating SI according to embodiments of the present disclosure.

FIG. 8 shows a block diagram illustrating an example apparatus for updating SI according to embodiments of the present disclosure.

FIG. 9 shows a block diagram illustrating an example apparatus for updating SI according to embodiments of the present disclosure.

FIG. 10 shows a block diagram illustrating an example apparatus for updating SI according to embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

According to embodiments of the present disclosure, the timed autonomous SI acquisition by the UE device, which is served by an IAB node that may later be undergoing inter-donor migration, may be prevented.

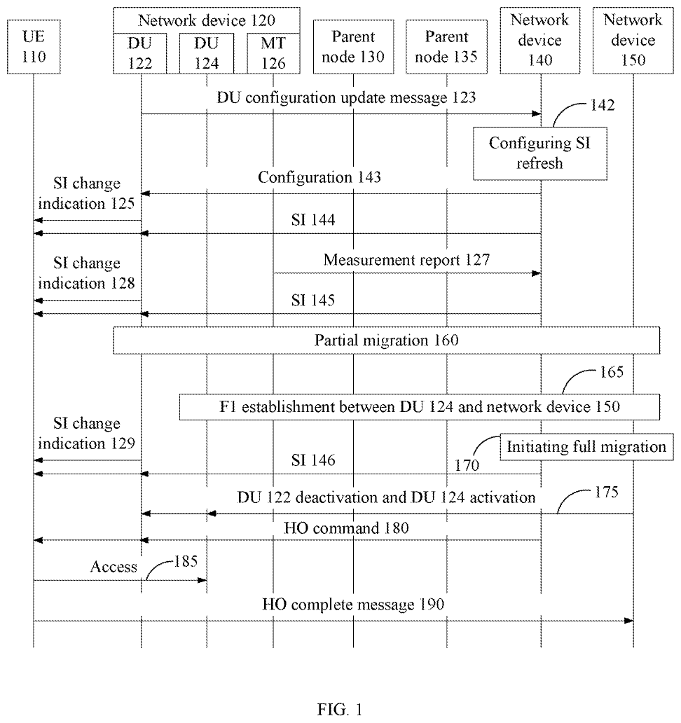

FIG. 1 shows an exemplary sequence diagram for updating SI according to embodiments of the present disclosure. Referring to the FIG. 1, a UE device 110 may represent any terminal device served by an IAB node in an IAB network. A network device 120 is associated with and may function as the IAB node. The network device 120 may comprise a DU 122, a DU 124, and a mobile termination (MT) 126. The DU 122 and the DU 124 are two logical DUs using the same physical cell resources and are associated with two cells residing on the same IAB node, respectively. A network device 140 is associated with and may function as an IAB donor with a CU in the IAB network, and a network device 150 is associated with and may function as another IAB donor with another CU in the IAB network.

Initially, it may be assumed that the network device 120 is in topology of the network device 140 and is connected to a parent node 130. For example, the MT 126 of the network device 120 has a radio resource control (RRC) connection to the network device 140, e.g., the CU of the network device 140, and the network device 120 has a F1 (interface between CU and DU) connection to the network device 140, e.g., the CU of the network device 140. The network device 120 may serve a cell in which the UE device 110 is connected to the network device 140 via the DU 122, and the network device 120 has a backhaul (BH) connection to the network device 140 via the parent node 130. The network device 120 is near a border of the topologies of the network device 140 and the network device 150 and may undergo inter-donor migration. For example, the network device 120 is potential to migrate from the topology of the network device 140 to the topology of the network device 150.

The UE device 110 may perform a SI acquisition procedure at an expiry of a period, e.g., 3 hours, starting from, e.g., successfully confirming the SIB1 as valid. In a case where the UE device 110 and possibly the MT 126 may be forced to reconfirm the stored SI before the expiry of the period, the period may be reset, and thus the period will not expire, such that the autonomous SI acquisition procedure by the UE device 110 may be prevented.

The migration of the network device 120 and the HO of the UE device 110 from the CU of the network device 140 to the CU of the network device 150 will be described below.

In an embodiment, since SIB1 is part of the SI owned by the DU according to F1 application protocol (F1AP), the network device 120, e.g., the DU 122 of the network device 120, may broadcast, to at least one first UE device associated with the cell of the DU 122, a SI change indication on the cell of the DU 122, before the expiry of the period after which the at least one first UE device autonomously acquires the SI on the cell of the DU 122. This period may be termed “first period” to distinguish with other periods in this disclosure. The SI may comprise a global cell identifier, e.g., the NCGI, of the cell, and the first UE device may be the UE device able to receive the broadcast SI change indication. The SI change indication may trigger the SI refresh at the at least one first UE device and prevent the autonomous SI acquisition procedure.

Alternatively or additionally, in a case where the UE devices associated with the cell of the DU 122 include at least one second UE device, which is unable to receive broadcast SI, the network device 120 may transmit, to the network device 140, an identifier of at least one second UE device, which may trigger the network device 140, e.g. a control plane (CP) of the CU (CU-CP) of the network device 140 to transmit, to the at least one second UE device, the SI, e.g., the SIB1, via a dedicated signaling. The SI via the dedicated signaling may comprise the global cell identifier, e.g., the NCGI, of the cell and may trigger the SI refresh at the at least one second UE device to prevent the autonomous SI acquisition procedure.

In an embodiment, a list of the identifier of the at least one second UE device may be included in a DU configuration update message 123 of the F1AP. In an embodiment, besides the list, the DU configuration update message 123 may also include up-to-date DU-owned SI per cell, such that the network device 140 may regularly transmit, via the dedicated signaling to the at least one second UE device, at least the SIB1 most recently received from the network device 120 and stored. The DU 122 of the network device 120 may transmit the DU configuration update message 123 to the CU-CP of the network device 140. Thus, this regular transmitting by the network device 140 may avoid the need for the DU 122 to initiate the F1AP DU configuration update procedure every time such dedicated signaling needs to be sent.

In a case where the UE device 110 is the first UE device, the UE device 110 may receive, the SI change indication from the network device 120, before the expiry of the first period, e.g. 3 hours. Alternatively, in a case where the UE device 110 is the second UE device, the UE device 110 may receive, the SI from the network device 140, before the expiry of the first period. The SI change indication or the SI may force the UE device 110 to refresh the SI, e.g., to reconfirm the stored SI as valid. For example, when receiving the SI change indication or the SI, the UE device 110 may restart the first period, such that the autonomous SI acquisition procedure by the UE device 110 may be prevented.

The transmissions of the SI change indication as well as the SI according to embodiments of the present disclosure will be hereinafter further described.

In an embodiment, in an operation 142, the network device 140, e.g., the CU-CP of the network device 140, may configure the network device 120 for a SI refresh forcing. For example, the network device 140 may configure the network device 120 for broadcasting the SI change indication to at least one first UE device associated with the cell of the DU 122 of the network device 120 before the expiry of the first period after which the at least one first UE device autonomously acquires the SI on the cell of the DU 122. Then, the network device 140 may transmit the configuration 143 to the network device 120, such that the network device 120 may broadcast the SI change indication according to the configuration 143. The configuration 143 may include, for example, when and whether the DU 122 of the network device 120 will broadcast the SI change indication. The configuration 143 may be transmitted via an information element (IE), e.g., a dedicated IE of the F1AP.

In an embodiment, the configuration 143 may include a second period for broadcasting the SI change indication, and the second period may be shorter than the first period. The network device 120 may regularly broadcast a SI change indication 125 according to the second period included in the configuration 143. By receiving the broadcast SI change indication 125, the at least one first UE device may be forced to update the SI with the second period shorter than the first period, such that the at least one first UE device may restart the first period before the expiry of the first period, and thus the autonomous SI acquisition procedure may be prevented.

In an embodiment, the configuration 143 may comprise information indicative of staring or stopping the broadcasting of the SI change indication 125. For example, in a case where the network device 140 is aware that the network device 120 is at or near a border of regions controlled by the CU-CP of the network device 140 and the CU-CP of the network device 150, the configuration 143 may comprise information indicative of staring the broadcasting of the SI change indication 125 for regularly updating the SI. In a case where the network device 140 is aware that the network device 120 is not to make inter-donor migration, the configuration 143 may comprise information indicative of stopping the DU 122 of the network device 120 from the periodical SI refresh forcing.

In an embodiment, the network device 140 may regularly initiate the SIB1 update by transmitting, via the dedicated signaling to the at least one second UE device, SI 144 with a third period. The third period may be shorter than the first period after which the at least one second terminal device autonomously acquires the system information. The third period may equal to the second period. The transmission of the SI 144 may be via the network device 120, e.g., the DU 122. Since the third period is shorter than the first period, the at least one second UE device may restart the first period before the expiry of the first period, and thus the autonomous SI acquisition procedure may be prevented.

The network device 140 may start the transmission of the SI 144 via the dedicated signaling in a case of being aware that the network device 120 is at or near the border between the topology of the network device 140 and the topology of the network device 150 and may stop the transmission of the SI 144 via the dedicated signaling in a case of being aware that the network device 120 is not to make the inter-donor migration.

Alternatively or additionally, in an embodiment, the SI refresh forcing may be initiated when the migration of the network device 120 is initiated. For example, the MT 126 of the network device 120 may transmit, to the CU of the network device 140, a measurement report 127 to initiate a MT migration from the parent node 130 to a parent node 135 based on a measurement configuration and a reporting configuration. The measurement report 127 may indicate that the parent node 135 is a suitable node or better than the parent node 130 for the BH connection.

Triggered by the measurement report 127 from the MT 126 to the CU of the network device 140, the network device 140 may firstly initiate a partial migration operation 160 where the MT 126 is handed over to the CU of the network device 150 while retaining the F1 connection for BH to the CU of the network device 140 which is the source CU.

In the partial migration operation 160, the DU 122 continues to serve the existing one or more cells and maintains the F1 connection to the CU of the network device 140, and the BH connection is routed to the network device 140 via the parent node 135.

At this stage, when the partial migration operation 160 is initiated, the CU of the network device 140 and/or the DU 122 of the network device 120 can initiate the SI refresh forcing, e.g., the SIB1 update for the UE devices to guarantee that the autonomous SI acquisition, e.g., SIB1 update, by the UE devices does not happen during a full migration procedure where the UE devices connected to the network device 120 hand over from the cell of the DU 122 controlled by the CU of the network device 140 to the cell of the DU 124 controlled by the CU of the network device 150.

For example, the network device 120 may broadcast, to the at least one first UE device, a SI change indication 128 when initiating the MT 126 to hand over from the network device 140 to the network device 150. By receiving the broadcast SI change indication 128, the at least one first UE device may be forced to update the SI, e.g., to update the SIB1, such that the at least one first UE device may restart the first period and prevent the autonomous SI acquisition procedure.

Alternatively, for example, the network device 140 may transmit, to the at least one second UE device, SI 145 via the dedicated signaling, when the MT 126 is to hand over from the network device 140 to the network device 150. The transmission of the SI 145 may be via the network device 120, e.g., the DU 122. The at least one second UE device may restart the first period before the expiry of the first period when receiving the SI 145 via the dedicated signaling, and thus the autonomous SI acquisition procedure may be prevented.

In a case where the partial migration operation 160 lasts close to the first period, the SI refresh forcing procedure can be reinitiated.

For example, the network device 120 may reinitiate the broadcasting of the SI change indication 128 before the expiry of the first period, in a case where a timing for a migration from the DU 122 associated with the network device 140 to the DU 124 associated with the network device 150 is after the expiry of the first period. Thus, the at least one first UE device may receive the reinitiated broadcast SI change indication 128 and restart the first period before the expiry of the first period, and the autonomous SI acquisition procedure by the at least one first UE device may be prevented.

Alternatively, for example, the network device 140 may reinitiate the transmission of the SI 145 via the dedicated signaling before the expiry of the first period after which the at least one second UE device autonomously acquires the SI, in a case where a timing for a migration from the DU 122 associated with the network device 140 to the DU 124 associated with the network device 150 is after the expiry of the first period. Thus, the at least one second UE device may receive the reinitiated transmitted SI 145 via the dedicated signaling and restart the first period before the expiry of the first period, and the autonomous SI acquisition procedure by the at least one second UE device may be prevented.

Then, as a preparation for the full migration procedure, in an operation 165 the DU 124 may initiate F1 interface setup to the CU of the network device 150 to establish F1 between the DU 124 and the CU of the network device 150. Thus the DU 124 establishes F1 to the CU of the network device 150 before the UE device 110 is handed over to a new/target cell.

In an operation 170 to initiate the full migration procedure, the CU of the network device 140 and the CU of the network device 150 may exchange information required for a change of the BH connection from the network device 140 to the network device 150. The CU of the network device 150 may become aware of synchronization signal block (SSB) and SIB1 configuration of the DU 122 such that a configuration of the DU 124 can be aligned.

Alternatively or additionally, in an embodiment, the SI refresh forcing may be initiated while the full migration procedure is ongoing.

For example, the network device 120 may broadcast, to the at least one first UE device, a SI change indication 129 when the migration from the DU 122 associated with the network device 140 to the DU 124 associated with the network device 150 is ongoing, e.g., at the beginning of the operation 170. Similar to the SI change indication 125 and the SI change indication 128, by receiving the SI change indication 129, the at least one first UE device may be forced to refresh, e.g., the SIB1 and restart the first period, and the autonomous SI acquisition procedure by the at least one first UE device may be prevented. The SI change indication 125, the SI change indication 128, and/or the SI change indication 129 may be broadcast in a physical downlink control channel (PDCCH) short message. The DU 122 may broadcast the PDCCH short message based in part on SI owned by the CU of the network device 140 and received over the F1.

Alternatively, for example, the network device 140 may transmit, to the at least one second UE device, SI 146 via the dedicated signaling when the migration from the DU 122 associated with the network device 140 to the DU 124 associated with the network device 150 is ongoing, e.g., at the beginning of the operation 170. The transmission of the SI 146 may be via the network device 120, e.g., the DU 122. Similar to the SI 144 and the SI 145, by receiving the SI 146 via the dedicated signaling, the at least one second UE device may be forced to refresh, e.g., the SIB1 and restart the first period, and the autonomous SI acquisition procedure by the at least one first UE device may be prevented.

Then, in an operation 175, the network device 150 may deactivate the DU 122 and activate the DU 124. In the operation 175, the SIB1 may change to indicate the NCGI of the CU of the network device 150. By the information exchange performed in the operation 170, the SSB configuration, a physical cell identifier (PCI), and coding of primary synchronization signal (PSS) and secondary synchronization signal (SSS) are the same for the DU 124 as were for the DU 122. This allows the UE device 110 to maintain the connection to the network device 120 when the DU 122 is de-activated and the DU 124 becomes active to serve the existing cells. A radio link management (RLM) measurement and a radio resource management (RRM) measurement at the UE device 110 can continue as in the source cell despite the change of the SIB1, and no radio link failure (RLF) will be caused.

Even though the NCGI of the cell of the network device 120 has changed, the connected UE device 110 is still RRC connected to the CU of the network device 140 which may transmit a HO command 180 to the UE device 110 with the target cell of the DU 124 and the cell with NCGI of the CU of the network device 150.

In an operation 185, the UE device 110 may initiate access procedure to the target cell of the DU 124. Then, the UE device 110 may transmit a HO complete message 190 for completing the full migration procedure, and the UE device 110 may move to the topology of the network device 150 and be served by the network device 150.

Thus, according to embodiments of the present disclosure, the UE device 110, which is a RRC connected UE device, remains connected, while observing the change of the NCGI and no change to the PCI.

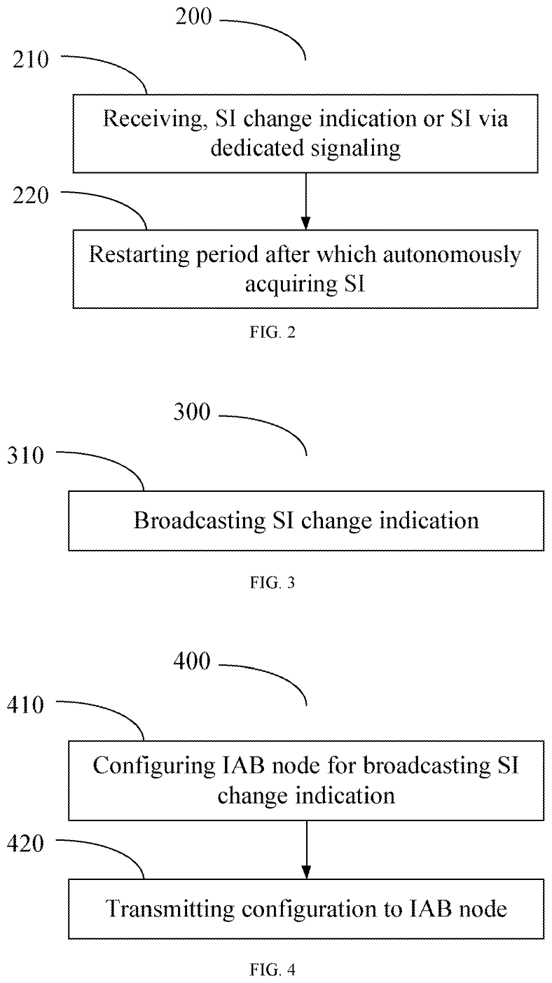

FIG. 2 shows a flow chart illustrating an example method 200 for updating SI according to embodiments of the present disclosure. The example method 200 may be performed for example at a terminal device such as the UE device 110.

Referring to the FIG. 2, the example method 200 may include an operation 210 of receiving, a SI change indication from a network device associated with an IAB node in the IAB network or SI via a dedicated signaling from another network device associated with a donor in the IAB network, before an expiry of a period after which the terminal device autonomously acquires the SI from the another network device; and an operation 220 of restarting the period in a case of receiving the SI change indication or the SI via the dedicated signaling.

Details of the operation 210 have been described in the above descriptions with respect to at least the UE device 110, the network device 120, and the network device 140, and repetitive descriptions thereof are omitted here.

Details of the operation 220 have been described in the above descriptions with respect to at least the UE device 110 and the first period, and repetitive descriptions thereof are omitted here.

FIG. 3 shows a flow chart illustrating an example method 300 for updating SI according to embodiments of the present disclosure. The example method 300 may be performed for example at a network device such as the network device 120.

Referring to the FIG. 3, the example method 300 may include an operation 310 of broadcasting, to at least one first terminal device associated with a cell of a DU of the IAB node, a SI change indication before an expiry of a first period after which the at least one first terminal device autonomously acquires SI on the cell.

Details of the operation 310 have been described in the above descriptions with respect to at least the first UE device and the network device 120, and repetitive descriptions thereof are omitted here.

In an embodiment, the example method 300 may further include an operation of transmitting, to a donor in the IAB network, an identifier of at least one second terminal device associated with the cell and unable to receive broadcast SI. The more details have been described in the above descriptions with respect to at least the second UE device and the DU configuration update message 123, and repetitive descriptions thereof are omitted here.

In an embodiment, the example method 300 may further include an operation of receiving, from a donor in the IAB network, a configuration for broadcasting the SI change indication, wherein the SI change indication may be broadcast according to the configuration. The more details have been described in the above descriptions with respect to at least the configuration 143 and the SI change indication 125, and repetitive descriptions thereof are omitted here.

In an embodiment, the configuration may comprise a second period for broadcasting the SI change indication, and the second period may be shorter than the first period. The more details have been described in the above descriptions with respect to at least the configuration 143 and the second period, and repetitive descriptions thereof are omitted here.

In an embodiment, the configuration may be received via an IE, and the configuration may comprise information indicative of staring or stopping the broadcasting of the SI change indication. The more details have been described in the above descriptions with respect to at least the configuration 143, and repetitive descriptions thereof are omitted here.

In an embodiment, the SI change indication may be broadcast when initiating a MT of the network device to hand over from the donor to another donor in the IAB network. The more details have been described in the above descriptions with respect to at least the MT 126, the measurement report 127, the partial migration operation 160 and the SI change indication 128, and repetitive descriptions thereof are omitted here.

In an embodiment, the example method 300 may further include an operation of reinitiating the broadcasting of the SI change indication before the expiry of the first period, in a case where a timing for a migration from the DU associated with the donor to a DU associated with the another donor in the IAB network is after the expiry of the first period. The more details have been described in the above descriptions with respect to at least the DU 122, the DU 124, the first period and the SI change indication 128, and repetitive descriptions thereof are omitted here.

In an embodiment, the SI change indication may be broadcast when a migration from the DU associated with the donor to a DU associated with the another donor in the IAB network is ongoing. The more details have been described in the above descriptions with respect to at least the DU 122, the DU 124, the operation 170 and the SI change indication 129, and repetitive descriptions thereof are omitted here.

In an embodiment, the SI change indication may be broadcast in a PDCCH short message. The more details have been described in the above descriptions with respect to at least the SI change indication 125, the SI change indication 128 and the SI change indication 129, and repetitive descriptions thereof are omitted here.

FIG. 4 shows a flow chart illustrating an example method 400 for updating SI according to embodiments of the present disclosure. The example method 400 may be performed for example at a network device such as the network device 140.

Referring to the FIG. 4, the example method 400 may include an operation 410 of configuring an IAB node in the IAB network for broadcasting a SI change indication to at least one first terminal device associated with a cell of a DU of the IAB node before an expiry of a first period after which the at least one first terminal device autonomously acquires SI on the cell; and an operation 420 of transmitting the configuration to the IAB node.

Details of the operation 410 have been described in the above descriptions with respect to at least the operation 142, and repetitive descriptions thereof are omitted here.

Details of the operation 420 have been described in the above descriptions with respect to at least the configuration 143, and repetitive descriptions thereof are omitted here.

In an embodiment, the configuration may comprise a second period for broadcasting the SI change indication, and the second period may be shorter than the first period. The more details have been described in the above descriptions with respect to at least the configuration 143 and the second period, and repetitive descriptions thereof are omitted here.

In an embodiment, the configuration may be transmitted via an IE, and the configuration may comprise information indicative of staring or stopping the broadcasting of the SI change indication. The more details have been described in the above descriptions with respect to at least the configuration 143, and repetitive descriptions thereof are omitted here.

In an embodiment, the example method 400 may further include an operation of receiving, from the IAB node, an identifier of at least one second terminal device associated with the cell and unable to receive broadcast SI, and an operation of transmitting, to the at least one second terminal device, the SI via a dedicated signaling. The more details have been described in the above descriptions with respect to at least the second UE device and the DU configuration update message 123, and repetitive descriptions thereof are omitted here.

In an embodiment, the SI may be transmitted with a third period, and the third period may be shorter than the first period after which the at least one second terminal device autonomously acquires the SI. The more details have been described in the above descriptions with respect to at least the second UE device and the third period, the first period and the SI 144, and repetitive descriptions thereof are omitted here.

In an embodiment, the SI may be transmitted when a MT of the IAB node is to hand over from the donor to another donor in the IAB network. The more details have been described in the above descriptions with respect to at least the MT 126, the measurement report 127, the partial migration operation 160 and the SI 145, and repetitive descriptions thereof are omitted here.

In an embodiment, the example method 400 may further include an operation of reinitiating the transmission of the SI before the expiry of the first period after which the at least one second terminal device autonomously acquires the SI, in a case where a timing for a migration from the DU associated with the donor to a DU associated with the another donor in the IAB network is after the expiry of the first period. The more details have been described in the above descriptions with respect to at least the DU 122, the DU 124, the first period and the SI 145, and repetitive descriptions thereof are omitted here.

In an embodiment, the SI may be transmitted when a migration from the DU associated with the donor to a DU associated with the another donor in the IAB network is ongoing. The more details have been described in the above descriptions with respect to at least the DU 122, the DU 124, the operation 170 and the SI 146, and repetitive descriptions thereof are omitted here.

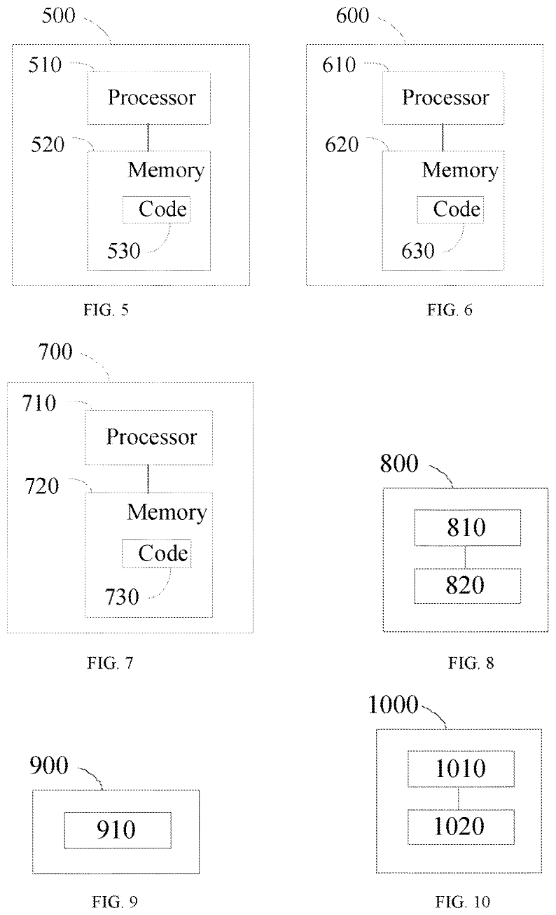

FIG. 5 shows a block diagram illustrating an example apparatus 500 for updating SI according to embodiments of the present disclosure. The apparatus, for example, may be at least part of a terminal device such as the UE device 110 in the above examples.

As shown in the FIG. 5, the example apparatus 500 may include at least one processor 510 and at least one memory 520 that may include computer program code 530. The at least one memory 520 and the computer program code 530 may be configured to, with the at least one processor 510, cause the apparatus 500 at least to perform the example method 200 described above.

In various example embodiments, the at least one processor 510 in the example apparatus 500 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 510 may also include at least one other circuitry or element not shown in the FIG. 5.

In various example embodiments, the at least one memory 520 in the example apparatus 500 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 520 may include, but are not limited to, an electric, a magnetic, an optical, an electromagnetic, an infrared, or a semiconductor system, apparatus, or device or any combination of the above.

Further, in various example embodiments, the example apparatus 500 may also include at least one other circuitry, element, and interface, for example at least one I/O interface, at least one antenna element, and the like.

In various example embodiments, the circuitries, parts, elements, and interfaces in the example apparatus 500, including the at least one processor 510 and the at least one memory 520, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the UE device 110 is not limited to the above example apparatus 500.

FIG. 6 shows a block diagram illustrating an example apparatus 600 for updating SI according to embodiments of the present disclosure. The apparatus, for example, may be at least part of a network device such as the network device 120 in the above examples.

As shown in the FIG. 6, the example apparatus 600 may include at least one processor 610 and at least one memory 620 that may include computer program code 630. The at least one memory 620 and the computer program code 630 may be configured to, with the at least one processor 610, cause the apparatus 600 at least to perform the example method 300 described above.

In various example embodiments, the at least one processor 610 in the example apparatus 600 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 610 may also include at least one other circuitry or element not shown in the FIG. 6.

In various example embodiments, the at least one memory 620 in the example apparatus 600 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 620 may include, but are not limited to, an electric, a magnetic, an optical, an electromagnetic, an infrared, or a semiconductor system, apparatus, or device or any combination of the above.

Further, in various example embodiments, the example apparatus 600 may also include at least one other circuitry, element, and interface, for example at least one I/O interface, at least one antenna element, and the like.

In various example embodiments, the circuitries, parts, elements, and interfaces in the example apparatus 600, including the at least one processor 610 and the at least one memory 620, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the network device 120 is not limited to the above example apparatus 600.

FIG. 7 shows a block diagram illustrating an example apparatus 700 for updating SI according to embodiments of the present disclosure. The apparatus, for example, may be at least part of a network device such as the network device 140 in the above examples.

As shown in the FIG. 7, the example apparatus 700 may include at least one processor 710 and at least one memory 720 that may include computer program code 730. The at least one memory 720 and the computer program code 730 may be configured to, with the at least one processor 710, cause the apparatus 700 at least to perform the example method 400 described above.

In various example embodiments, the at least one processor 710 in the example apparatus 700 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 710 may also include at least one other circuitry or element not shown in the FIG. 7.

In various example embodiments, the at least one memory 720 in the example apparatus 700 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 720 may include, but are not limited to, an electric, a magnetic, an optical, an electromagnetic, an infrared, or a semiconductor system, apparatus, or device or any combination of the above.

Further, in various example embodiments, the example apparatus 700 may also include at least one other circuitry, element, and interface, for example at least one I/O interface, at least one antenna element, and the like.

In various example embodiments, the circuitries, parts, elements, and interfaces in the example apparatus 700, including the at least one processor 710 and the at least one memory 720, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the network device 140 is not limited to the above example apparatus 700.

FIG. 8 shows a block diagram illustrating an example apparatus 800 for updating SI according to embodiments of the present disclosure. The apparatus, for example, may be at least part of a terminal device such as the UE device 110 in the above examples.

As shown in FIG. 8, the example apparatus 800 may include means 810 for performing the operation 210 of the example method 200, and means 220 for performing the operation 220 of the example method 200. In one or more another example embodiments, at least one I/O interface, at least one antenna element, and the like may also be included in the example apparatus 800.

In some example embodiments, examples of means in the example apparatus 800 may include circuitries. For example, an example of means 810 may include a circuitry configured to perform the operation 210 of the example method 200, and an example of means 220 may include a circuitry configured to perform the operation 220 of the example method 200. In some example embodiments, examples of means may also include software modules and any other suitable function entities.

FIG. 9 shows a block diagram illustrating an example apparatus 900 for updating SI according to embodiments of the present disclosure. The apparatus, for example, may be at least part of a network device such as the network device 120 in the above examples.

As shown in FIG. 9, the example apparatus 900 may include means 910 for performing the operation 310 of the example method 300. In one or more another example embodiments, at least one I/O interface, at least one antenna element, and the like may also be included in the example apparatus 900.

In some example embodiments, examples of means in the example apparatus 900 may include circuitries. For example, an example of means 910 may include a circuitry configured to perform the operation 310 of the example method 300. In some example embodiments, examples of means may also include software modules and any other suitable function entities.

FIG. 10 shows a block diagram illustrating an example apparatus 1000 for updating SI according to embodiments of the present disclosure. The apparatus, for example, may be at least part of a network device such as the network device 140 in the above examples.

As shown in FIG. 10, the example apparatus 1000 may include means 1010 for performing the operation 410 of the example method 400, and means 1020 for performing the operation 420 of the example method 400. In one or more another example embodiments, at least one I/O interface, at least one antenna element, and the like may also be included in the example apparatus 1000.

In some example embodiments, examples of means in the example apparatus 1000 may include circuitries. For example, an example of means 1010 may include a circuitry configured to perform the operation 410 of the example method 400, and an example of means 1020 may include a circuitry configured to perform the operation 420 of the example method 400. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
BH backhaul
CP control plane
CU central unit
DU distributed unit
IE information element
F1 interface between CU and DU
F1AP F1 application protocol
HO handover
IAB integrated access and backhaul
MT mobile termination
NCGI new radio cell global identifier
PCI physical cell identifier
PDCCH physical downlink control channel
PSS primary synchronization signal
RLF radio link failure
RLM radio link management
RRC radio resource control
RRM radio resource management
SI system information
SIB1 system information block 1
SSB synchronization signal block
SSS secondary synchronization signal
UE user equipment

1.-42. (canceled)

43. An apparatus comprising:
at least one processor; and
at least one memory comprising computer program code, the at least one memory and the computer program code being configured to, with the at least one processor, cause the apparatus as a terminal device in an integrated access and backhaul network to perform:
receiving, a system information change indication from a network device associated with an integrated access and backhaul node in the integrated access and backhaul network or system information via a dedicated signaling from another network device associated with a donor in the integrated access and backhaul network, before an expiry of a period after which the terminal device autonomously acquires the system information from the another network device; and
restarting the period in a case of receiving the system information change indication or the system information via the dedicated signaling.

44. An apparatus comprising:
at least one processor; and
at least one memory comprising computer program code, the at least one memory and the computer program code being configured to, with the at least one processor, cause the apparatus as a network device associated with an integrated access and backhaul node in an integrated access and backhaul network to perform:
broadcasting, to at least one first terminal device associated with a cell of a distributed unit of the integrated access and backhaul node, a system information change indication on the cell before an expiry of a first period after which the at least one first terminal device autonomously acquires system information on the cell.

45. The apparatus of claim 44, the at least one memory and the computer program code are further configured to, with the at least one processor, cause the apparatus to further perform:
transmitting, to a donor in the integrated access and backhaul network, an identifier of at least one second terminal device associated with the cell and unable to receive broadcast system information.

46. The apparatus of claim 44, the at least one memory and the computer program code are further configured to, with the at least one processor, cause the apparatus to further perform:
receiving, from a donor in the integrated access and backhaul network, a configuration for broadcasting the system information change indication, wherein
the system information change indication is broadcast according to the configuration.

47. The apparatus of claim 46, wherein the configuration comprises a second period for broadcasting the system information change indication, and the second period is shorter than the first period.

48. The apparatus of claim 46, wherein the configuration is received via an information element, and the configuration comprises information indicative of starting or stopping the broadcasting of the system information change indication.

49. The apparatus of claim 44, wherein the system information change indication is broadcast when initiating a mobile termination of the network device to hand over from the donor to another donor in the integrated access and backhaul network.

50. The apparatus of claim 49, wherein the at least one memory and the computer program code are further configured to, with the at least one processor, cause the apparatus to further perform:
reinitiating the broadcasting of the system information change indication before the expiry of the first period, in a case where a timing for a migration from the distributed unit associated with the donor to a distributed unit associated with the another donor in the integrated access and backhaul network is after the expiry of the first period.

51. The apparatus of claim 49, wherein the system information change indication is broadcast when a migration from the distributed unit associated with the donor to a distributed unit associated with the another donor in the integrated access and backhaul network is ongoing.

52. The apparatus of claim 44, wherein the system information change indication is broadcast in a physical downlink control channel short message.

53. An apparatus comprising:
at least one processor; and
at least one memory comprising computer program code, the at least one memory and the computer program code being configured to, with the at least one processor, cause the apparatus as a network device associated with a donor in an integrated access and backhaul network to perform:
configuring an integrated access and backhaul node in the integrated access and backhaul network for broadcasting a system information change indication to at least one first terminal device associated with a cell of a distributed unit of the integrated access and backhaul node before an expiry of a first period after which the at least one first terminal device autonomously acquires system information on the cell; and
transmitting the configuration to the integrated access and backhaul node.

54. The apparatus of claim 53, wherein the configuration comprises a second period for broadcasting the system information change indication, and the second period is shorter than the first period.

55. The apparatus of claim 53, wherein the configuration is transmitted via an information element, and the configuration comprises information indicative of starting or stopping the broadcasting of the system information change indication.

56. The apparatus of claim 53, wherein the at least one memory and the computer program code are further configured to, with the at least one processor, cause the apparatus to further perform:
receiving, from the integrated access and backhaul node, an identifier of at least one second terminal device associated with the cell and unable to receive broadcast system information, and
transmitting, to the at least one second terminal device, the system information via a dedicated signaling.

57. The apparatus of claim 56, wherein the system information is transmitted with a third period, and the third period is shorter than the first period after which the at least one second terminal device autonomously acquires the system information.

58. The apparatus of claim 56, wherein the system information is transmitted when a mobile termination of the integrated access and backhaul node is to hand over from the donor to another donor in the integrated access and backhaul network.

59. The apparatus of claim 58, wherein the at least one memory and the computer program code are further configured to, with the at least one processor, cause the apparatus to further perform:
reinitiating the transmission of the system information before the expiry of the first period after which the at least one second terminal device autonomously acquires the system information, in a case where a timing for a migration from the distributed unit associated with the donor to a distributed unit associated with the another donor in the integrated access and backhaul network is after the expiry of the first period.

60. The apparatus of claim 58, wherein the system information is transmitted when a migration from the distributed unit associated with the donor to a distributed unit associated with the another donor in the integrated access and backhaul network is ongoing.
